(19) United States
(12) Patent Application Publication
(10) Pub. No.: US 2022/0128187 A1
(43) Pub. Date: Apr. 28, 2022

(54) System and Apparatus For Slidable Carriage

(71) Applicant: Kiosk Group, Inc., Frederick, MD (US)

(72) Inventor: Michael K. James, Frederick, MD (US)

(73) Assignee: Kiosk Group, Inc., Frederick, MD (US)

(21) Appl. No.: 17/425,021

(22) PCT Filed: Jan. 23, 2020
(86) PCT No.: PCT/US20/14765

§ 371 Date: Jul. 22, 2021

Related U.S. Application Data
(60) Provisional application No. 62/796,948, filed on Jan. 25, 2019.

(51) Int. Cl. F16M 11/04; A47F 10/02; F16M 11/18

(52) U.S. Cl. CPC F16M 11/046; F16M 11/18; A47F 10/02

(57) ABSTRACT

A kiosk apparatus with a first carriage assembly attached to an interface member. A second carriage assembly is attached to one or more weights and a linkage connects the first carriage assembly to the second carriage assembly in a movable relationship such that as one of the first carriage assembly or the second carriage assembly moves in a first path, the other assembly moves in a second path, the first path being different than a second path.

### CLAIM TO PRIORITY

This is application claims a priority benefit to U.S. Ser. No. 62/796,948 filed Jan. 25, 2019.

### FIELD OF THE DISCLOSURE

The present disclosure relates generally to kiosks and display devices attached to an interface member of a carriage. The carriage with the display device moves up and down in a substantially vertical path.

### BACKGROUND

Many conventional display devices are mounted on a wall of a room or other surface. These conventional display devices typically utilize an angled, or tilted, screen to display information to a user. Unfortunately, the tilted display devices are often not ADA (Americans with Disabilities Act) compliant because the tilted screen causes a lower portion of the screen to extend beyond an upper portion of the screen. The angled screen being extended beyond the upper portion of the screen causes the screen to be an obstacle in an area, such as a hallway, room, walkway or other area. It would be an advancement in the art to provide a kiosk that included a screen that was substantially oriented in a non-protruding manner that could be maintained in an number of positions on the frame of the kiosk.

Additionally, some conventional display devices require a motor or electronics to move the screen from one position to another position.

### BRIEF DESCRIPTION OF THE DRAWINGS

The accompanying drawings provide visual representations, which will be used to more fully describe various representative embodiments and can be used by those skilled in the art to better understand the representative embodiments disclosed and their inherent advantages. In these drawings, like reference numerals identify corresponding elements.

FIG. 1 illustrates a perspective front view of a kiosk according to embodiments described herein.

FIG. 2 shows front and rear portions of a kiosk according to embodiments described herein.

FIG. 3 shows a partial side view of a kiosk according to embodiments described herein.

FIG. 4 shows a rear view of a kiosk according to embodiments described herein.

FIG. 5 shows another side/rear view of a kiosk according to embodiments described herein.

FIG. 6 shows yet another side/rear view of a kiosk according to embodiments described herein.

FIG. 7 shows an embodiment that includes a stand-alone frame and an extendable arm member.

### DETAILED DESCRIPTION

The Americans with Disabilities Act (ADA), which was passed by Congress in 1990, is the nation's first comprehensive civil rights law addressing the needs of people with disabilities, prohibiting discrimination in employment, public services, public accommodations, and telecommunications.

The ADA guarantees the right of individuals with disabilities to receive reasonable accommodations in order to work and participate in all aspects of society. It prohibits disability discrimination.

The complexity of issues arising under the ADA required developing a series of policy guidelines designed to clarify and interpret the provisions of the law. Between 1993 and 1999, EEOC (equal employment opportunity commission) issued eight enforcement guidelines, which have provided interpretations on key ADA issues, including pre-employment inquiries and medical examinations, workers' compensation benefits, psychiatric conditions, the meaning of the term “qualified,” and the requirement that employers provide reasonable accommodations.

One of the EEOC guidelines is that office appliances must be no higher than forty-eight inches (48 inches (four feet)) from a floor surface. This allows individuals in wheelchairs to be able to reach appliances in buildings and offices. OSHA and most municipal fire codes require that wall mounts do not extend any further than four inches from the surface of a wall, thereby preventing obstruction of ingress and egress, particularly in an emergency situation, such as fire or emergency evacuation.

Many office buildings facilitate notification of the location of meetings, or other information with the use of kiosks, or display screens, to provide clear and updated information regarding the activities in the building. These kiosks and display screens can be updated or revised remotely and can be viewed by individuals throughout the building.

In order to comply with OSHA and the ADA, as well as make the display system as efficient as possible, it would be useful to have display screens that are able to be moved higher or lower, depending on the height of the person viewing the display. This is particularly true for access by those in wheelchairs or of diminutive stature.

In order to meet the requirements of ADA and OSHA, as well as providing ergonomically efficient and flexible positioning, it is useful to be able to change the height, rotation, orientation, viewing angles, and content of a display, especially a flat display.

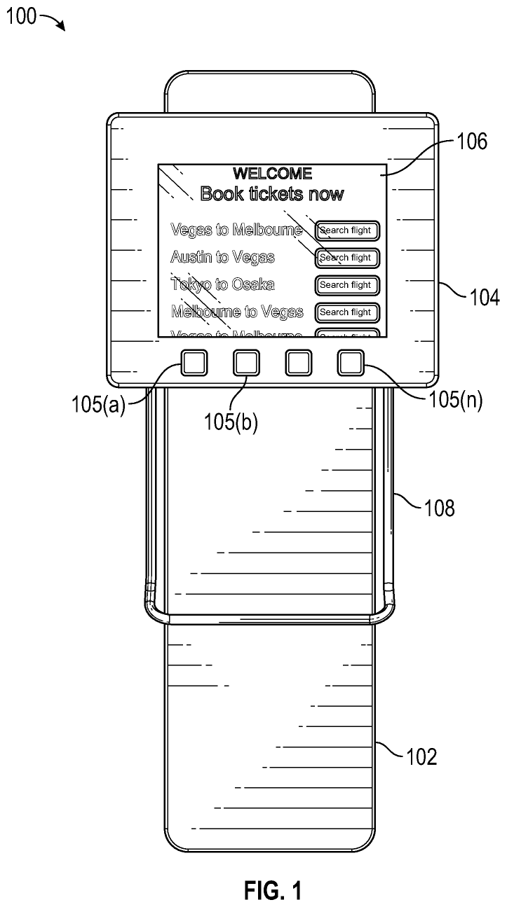

FIG. 1 illustrates a perspective view of a kiosk 100 according to embodiments described herein. The kiosk 100 is a height-adjustable kiosk that is ADA compliant because at the highest position of the display, a lower portion of the display, or actuator if the kiosk has an actuator, will have a maximum height of 48 inches from the floor or ground.

The embodiment of FIG. 1 is shown as unit configured to be mounted on a wall or other support structure. In addition to being mounted to a wall, embodiments, as described herein, may be affixed to a support surface, or structure, such as a wall, pole, beam or other suitable support.

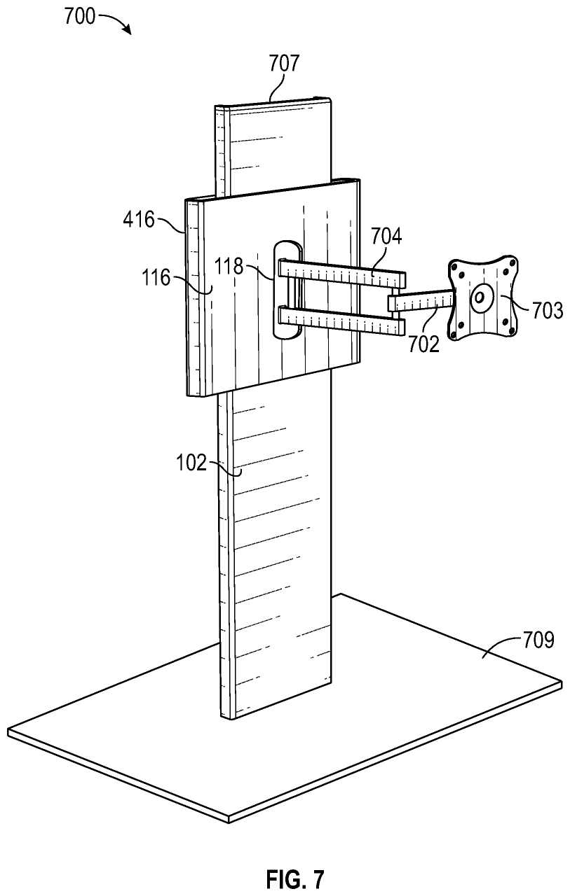

Alternatively, as described herein, the kiosk 100 may be a stand-alone unit that does not require any additional support structure. An example of the stand-alone unit embodiment is shown in FIG. 7 herein.

The kiosk 100 includes a frame 102, device 104 with a screen 106, menu buttons 105(a) . . . (n) (where “n” is any suitable number) and an actuator 108, which is shown as a generally U-shaped handle that is substantially circular in cross section.

The frame 102 is typically made from metal, plastic, wood or other suitable material. The frame 102 is used to house or support the components of the kiosk that permit the device 104 to move in a substantially vertical direction. The frame may be a stand-alone apparatus or may be mounted to a support or structure. The dimensions of the frame 102 are typically based, at least in part, on the type of device 104 that is mounted to the frame 102.

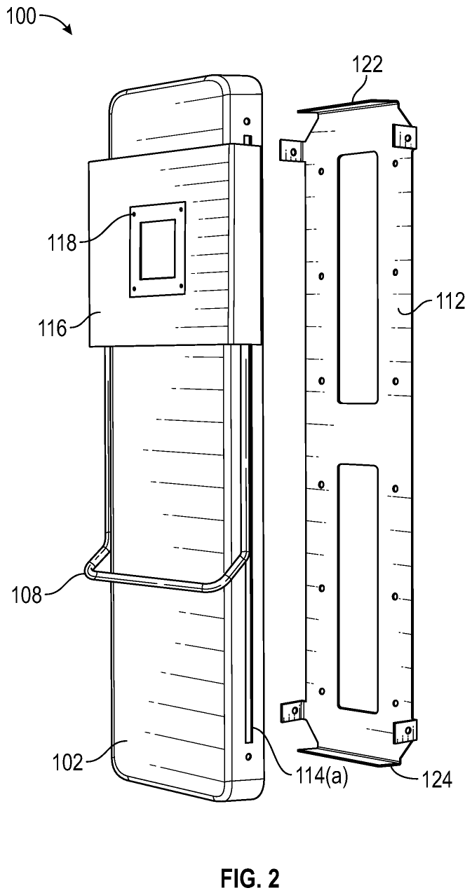

The frame 102 is designed to have sufficient strength and weight such that the frame 102 provides safe and adequate support of any device or object 104 affixed to the frame 102 via interface member (shown as 116 in FIG. 2 herein). The frame 102 may be any suitable dimensions and the dimensions are not critical.

Device 104 is shown as a tablet with a screen, or display, 106. Device 104 may be any suitable object, such as a computer, computer screen, camera, a smartphone, artwork, a tablet, a dispensing device, a graphical user interface, a biometric sensing device, iris scanning device, credit card reader apparatus, debit card reader apparatus, or other electronic transaction device, or electronic payment device such as APPLE® pay, or other technique using an Internet enabled device.

The device, or object 104 may also be an articulating arm, such as a mechanical arm, retractable arm, or other suitable extension that may be affixed to the interface member, as described herein. Additional devices, such as those identified above, may be mounted to the mechanical arm, such that the movement of the arm will move any device or object attached to the arm.

The device 104 is affixed to an interface member as shown herein. The device 104 may be changed, or substituted, depending on what type of device 104 is desired to be affixed to the kiosk frame 102.

At the highest point, the device or actuator or handle is ADA compliant. At the lowest point, the screen or display 106 is ADA compliant. Thus, a user can access the displayed information at eye level regardless of physical abilities of the user.

The device or object 104 may be a touch screen or any suitable object that may be mounted on interface member. These objects may include, inter alia, a camera, tablet, laptop, computer screen, artwork, GUI (graphical user interface), printed placard, poster or other electronic device and/or printed or decorative material, or biometric sensing device, or iris scanner, credit card reader electronic payment terminal, ticket dispenser or other suitable device.

Display, or screen, 106 may be part of the device 104. It is an embodiment that the device 104 may or may not have a screen, or display, 106.

The screen, or display, 106 may display content, data, business information, information or other desired graphic. The display 106 can include content that changes or is modified, such as news data, financial data, entertainment data and other suitable images, graphics or representations that can be displayed.

Various menu buttons 105(a) . . . (n) where “n” is any suitable number are show as part of the device 104. In an embodiment utilizing different devices, the menu buttons 105 may not be part of a different device.

The display 106 and/or object 104 may be disposed so that the display 106 and/or object 104 is substantially vertical in orientation and does not have a portion that extends substantially beyond another portion of the display 106 and/or object 104. Thus, a display 106 and/or object 104 may maintain a substantially vertical disposition.

Actuator, or handle, 108 is any suitable apparatus that may be used to move the display 104 in a substantially vertical direction along frame 102. The actuator 108 may be a cord, knob, string, substantially U-shaped, tube, such as a metal tube having substantially circular cross section, or any suitable apparatus affixed or used to move the device, or object 104.

The actuator 108 may be biased with springs, or weights or levers to facilitate actuation. The weight of the actuator 108, if present, is included in the mass of the first carriage assembly 132, since the counter-weights 136 are used to maintain a position of the first carriage 132 relative to the frame 102.

The actuator 108 may also be collapsible, or retractable such that a user may extend the actuator for ease of use. The actuator 108 is suitably retractable so that it does not extend more than 4 inches from the frame 102 when it is in a retracted or constricted position. Indeed, the actuator 108 may be biased to retract closer to the frame when it is not in use.

The kiosk 100 is ADA compliant because the actuator, or handle, 108 is designed to be at a maximum of 48 inches above a floor surface when the device 104 with display 106 is at the highest position on frame 102.

Pulling or exerting a force on the actuator 108, shown as a bar, or handle, causes the device 104 with display 106 to move up or down in a substantially vertical path along frame 102.

Alternatively, in an embodiment in which there is no actuator 108, the device 104 may be designed to be no higher than 48 inches from a floor surface. A user can press or pull or otherwise exert force on the device 104 and the device 104 with display 106 will move vertically down frame 102.

Alternatively, the kiosk 100 may be mounted to a wall or other structure and may be at any desired height, which may, or may not, be ADA and/or OSHA compliant. The fact that the kiosk 100 is designed to be ADA and/or OSHA compliant does not mean that every implementation or instantiation of the kiosk 100 must be ADA and/or OSHA compliant.

FIG. 2 shows a front and rear portion of a kiosk 100 according to embodiments described herein.

The embodiment of the kiosk 100 shown in FIG. 2 comprises the frame 102, interface member or interface element, or interface plate, 116 with mounting member 118, actuator 108, which is shown as a handle. Also shown is slot, or opening, 114(a) and back portion 112 with upper portion 122 and lower portion 124.

The interface member, or interface element, or interface plate, 116 may support any object that is mounted on the interface member, element or plate 116. These may be any suitable object and the interface member 116 may be adapted to support interchangeable objects. Indeed, interface member 116 may support, or be attached to, a computer, a graphical user interface, electronic tablet, smart phone, plaque, computer monitor, I/O (input/output) device, poster board or other suitable object.

The interface member 116 may be positioned such that any object affixed thereto does not extend beyond the ADA stipulated protrusion distance from the front surface of an object or device affixed to the interface member 116.

As stated above, the interface member, or element, or plate, 116 may also be attached to an extendable arm, articulating arm, hinged arm or other attachment as illustrated in FIG. 7 herein.

As shown in FIGS. 1, 2 and 3 herein, the interface plate, member or element 116 may be a portion of the first carriage as described herein. The first carriage (132) includes a portion that is behind the plate member 116 and is connected to a linkage (138) so that the plate portion 116 moves in a vertical direction based, at least in part, on movement of the second carriage (134).

The mounting member or mounting plate or mounting surface 118 may be any suitable plate, adapter, fixture, surface or orifice that may be used to affix an object or device (104 in FIG. 1) to the interface member 116. The mounting surface 118 may be pre-drilled holes to receive mounting screws, nails, bolts, adhesive or other attachment mechanism to attach a device or object to the interface plate 118.

The slot 114(a) is shown as an opening along a side surface of frame 102. The slot 114(a) provides a path or track for interface member 116 to slide vertically along frame 102. The slot 114(a) has dimensions such that the interface member 116 moves in the slot 114(a) via a first carriage, as described herein. The interface member 116 is configured to move up and/or down in opening or slot 114(a). The movement of interface plate 116 moves an object or device (104) in a substantially vertical direction on frame 102.

The back portion 112 may be used to mount or hang the frame 102 to a wall, support or other suitable mounting surface to support the kiosk 100.

The back portion 112 has upper surface 122 and lower surface 124. The back portion 112 may be fabricated from metal, plastic, wood, composite material or any suitable material that provides sufficient strength and support for the frame 102, interface plate 116 and any objects, devices or articles, arms (objects devices or articles are generally shown as 104 and arms are shown as 704 herein) attached or connected to the interface plate, or interface member, 116.

The back portion 112 is sized to conform to the frame 102, such that the back portion 112 functions as additional structure and support for the frame 102.

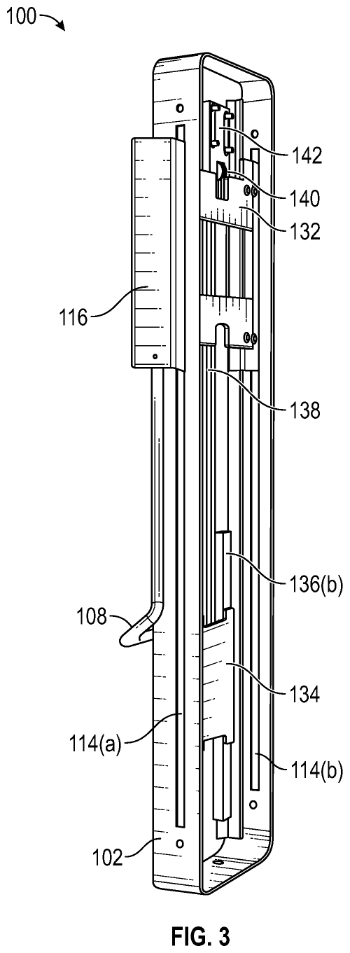

FIG. 3 shows a partial side view of a kiosk 100 according to embodiments described herein. The kiosk 100, as shown in FIG. 3, includes frame 102, interface member 116, actuator 108, a first carriage 132, second carriage 134, weights 136, linkage 138, pulley 140 and slots 114(a) and 114(b).

A first carriage 132 is attached or affixed to the interface member 116 such that movement of the first carriage 132 causes the interface member 116, including any objects or devices (104) attached to the interface member 116 to move. The first carriage 132 with the interface member 116 moves in slots 114(a) and 114(b). The first carriage is attached to second carriage 134 via linkage 138. The first carriage 132 may be fabricated from metal, plastic, polymer or other suitable material.

The first carriage 132 and the interface member 116 may be a single unit. Thus, the interface member 116 may be a portion of the first carriage 132. The interface surface 116 may be detached from the first carriage 132 so that a different interface, or mounting plate may be connected to the first carriage 132. The use of a substitute interface or mounting plate 116 may be desired based on the use of an object or device attached to the mounting surface 116.

The second carriage 134 is attached to the first carriage 132 via linkage 138. The second carriage 134 has weights 136 such that the second carriage 134, with weights 136, is substantially equal in mass to the combined mass of the first carriage, interface member 116 and any objects or devices attached to the interface member 116. This determination of the mass of the components enables the desired counter-balance weight to be used. This enables the interface member 116 and devices or objects mounted thereto to remain in a desired or selected position on the frame 102.

The second carriage 134 can be a single unit with weights 136.

Actuation of the device, or object (104) attached to interface member 116 causes the second carriage 134 to move in a vertical direction opposite to the vertical direction of the first carriage 132, interface member 116 and objects or devices (104). The second carriage 134 may be fabricated from metal, plastic, polymer or other suitable material.

The weights 136(a) and 136(b) (generally 136) are attached, or affixed to second carriage 134 to provide a counter weight to the first carriage 132 (including interface member 116 and objects or devices (104)). The weights 136 are used to counter balance the mass of the first carriage assembly (132, 116) including any objects or devices 104. The weights 136 are counter weights used to counter balance the mass of the first carriage assembly. The weights 136 may be based, at least in part, on the desired mass for the second carriage 134. The weights 136 may be fabricated from metal, alloy, or other suitable material. The weights 136 may be disposed on opposite sides of the second carriage 134.

The weights may be placed so that approximately one-half of the weights are on the right side of the second carriage and one-half of the weights are located on the left side of the second carriage 134. The magnitude of weights 136 is based, at least in part, on the mass of the interface member 116, first carriage 132 and any object and/or devices (104) that may be attached to the interface member 116.

Typically, the weights may be between approximately 0.5 pounds to approximately 200 pounds. The scale and size of the frame 102 are suitable to house or hold the weights 136.

Alternatively, the frame may be mounted to a wall, or other shielding structure. In this embodiment, the weights 136 may not necessarily need to be housed in the frame 102, since the wall can provide the support for the weights 136.

The second carriage 134 may have various holders or supports, as part of the second carriage 134, such that the weights 136 may be modified or changed. By changing the weights 136 of second carriage 134, the total mass of the second carriage 134, and weights 136, is configured to be changed. Thus, the mass of the second carriage 134 and weights 136 is dynamic and can be modified based, at least in part, on the total mass of the first carriage 132, interface member 116 and object (104).

Alternatively, the weights 136 can be a stack of weight plates affixed to the second carriage 134 such that a pin or clip can be used to select a desired section or portion of the weights 136. Thus, the stack of weight plates can be disposed on the bottom of frame 102 and a pin can select the amount of weight, by the number of plates selected, to be used with the second carriage 134.

The linkage 138 operatively couples first carriage 132 to second carriage 134. Thus, when a user actuates either an object (104), actuator (108) or interface member 116, the first carriage can move either up or down, depending on the direction of the force exerted on the object (104), actuator (108) or interface member 116. As the first carriage 132 moves either up or down, the second carriage 134, with associated weights 136, moves in an opposite direction since the first carriage 132 is link to the second carriage 134 via linkage 138.

The linkage 138 may be a belt, chain, rope, cord, polymer material, composite material, fiber, cotton, silk or other suitable material with the necessary tensile strength and flexibility to provide mechanical operation or movement between the first carriage 132 and the second carriage 134.

In an embodiment in which the linkage 138 is a belt, the belt 138 may have teeth or grooves 509 on an interior surface to facilitate contact of the belt with other components, such as pulley 140. The teeth 509 or other components on the linkage 138, such as a belt, are optional and may merely enhance the operation of the linkage.

Pulley 140 provides a biasing, or guidance path for the linkage 138. The pulley 140 enhances the movement, or path for linkage 138. The pulley 140 may be fabricated from plastic, metal, polymer material or other suitable material.

It is also an embodiment that the pulley 140 may be a surface, or rod affixed to the interior of the frame 102 that the linkage moves over the surface or the rod to operate the motion of the first carriage 132 and the second carriage 134.

Slots 114(a) and 114(b) are in opposite sides of the frame 102 to provide a path for the interface member 116 and the first carriage 132, which are connected, to move in a vertical direction.

The slots 114(a) and 114(b) (generally 114) are dimensioned based, at least in part, on the dimensions of the first carriage 132 and/or interface member 116. The slots 114 may be the majority of the length of frame 102 or any portion of the length of frame 102.

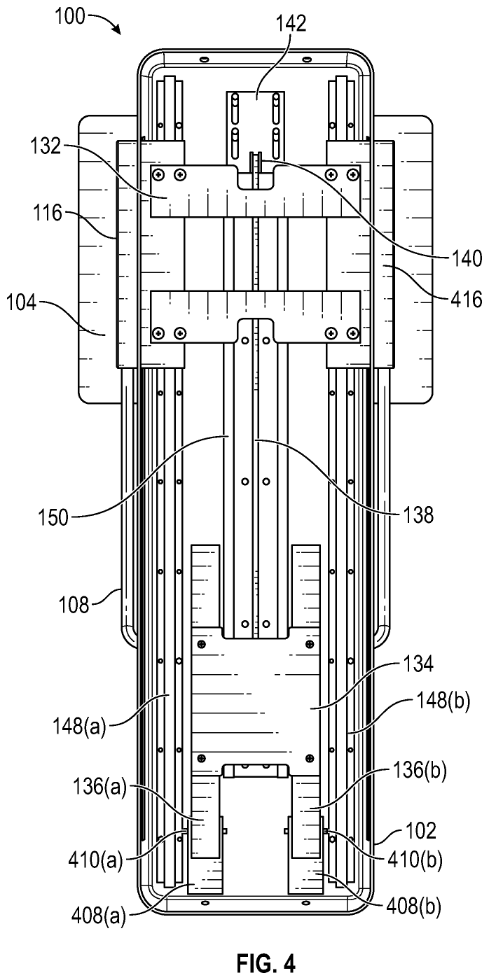

FIG. 4 shows a rear view of a kiosk 100 according to embodiments described herein.

FIG. 4 shows interface member 116, first carriage 132, as single element 416, device 104, pulley 140, second carriage 134, weights 136(a), 136(b), weight stacks 408(a) 408(b), pins 410(a), 410(b), linkage 138, actuator 108, middle support rail 150, and side support rails 148(a) and 148(b).

The weight stacks 408(a) and 408(b) are attached to second carriage 134. They may be attached to second carriage via a cable or wire or other suitable attachment device or mechanism. Weight stack, or weight plates, 408(a) may be attached to weights 136(a) via pin 410(a). Weight stack, or weight plates, 408(b) may be attached to weights 136(b) via pin 410(b). Thus, the number of additional weight plates, generally 408, can be selected by use of pin 410. This modification of weights modifies the mass of second carriage 134. The modification of the mass of second carriage 134 with weights 408 enables various attachments to interface plate 116.

As stated above, single weight or a plurality of weights could be used. The weight may be established, modified, or changed based on the mass of the first carriage 132 including the interface member 116 (416) and any object mounted or affixed to the interface member 116. As the object affixed to the interface member 116 is changed, the one or more weights may be changed by adjusting the pin or by changing the weight of the second carriage 134.

Thus, the mass of first carriage 416 (first carriage 132 with interface member 116) may be changed by using various objects or devices attached to plate 116. The selectable weights enable the mass of the first carriage 134 to be substantially equal to the mass of the second carriage 416 including any objects or devices attached to the first carriage 416.

The first carriage can be disposed at any location in the vertical path of frame 102. Thus a user may exert a force on either the interface plate 116, the device 104 or actuator 108 and cause the first carriage to remain at a desired position until another force is exerted on the interface plate 116, device 104 or actuator to cause movement.

As described herein, the weights 136, 408, are used as a counterweight for the interface member 116 or first carriage assembly 132 when the interface member 116 is an integral component of the first carriage assembly 132 and any objects or devices (104, arm 704 as shown in FIG. 7 herein) mounted to the interface member 116/first carriage assembly 132.

The weights 136, 408 are selected, including a dynamic selection of the magnitude of the weight using pin, or selector 410 such that the first carriage assembly 132, including all attachments, such as objects or devices 104, arm 704 with any devices or objects attached to the arm 704, such that the weights attached to the second carriage assembly 134 cause the first carriage assembly 132 with all object or devices 104 to stay in a position after actuation by a user. The first carriage assembly 132 will typically maintain a static position until another force is exerted on the first carriage assembly 132, device or object 104, or actuator 108.

Thus, a user can move the first carriage assembly in either direction merely by exerting a force on a portion of the first carriage assembly 132, device or object 104, or actuator 108. Once the user has moved the first carriage assembly 132 into a desired position, the carriage assembly 132 will maintain that position.

Some or all of the weights 136, 408, which are used to counterbalance the display screens, or devices, or objects 104, which may augment the mass of second carriage assembly 134 may be removed from the frame 102. This removal feature facilitates portability of the apparatus 100 since the mass or weight of the apparatus 100 will decrease when the weights 136, 408 are capable of being removed from the apparatus 100 prior to moving the apparatus.

The kiosk 100, as described herein may be a free-standing device that does not use any support structure. Alternatively, the kiosk 100 could be mounted to a support structure, such as a wall, post, beam or other suitable structure.

Additionally, the kiosk apparatus 100 as described herein may be portable. Since the kiosk 100 can operate independent of a motor, the overall mass of the kiosk 100 is less. Furthermore, removal of the counterweights (136 408) facilitates transport of the kiosk 100.

The use of additional weights 408 may also enhance the stability properties of the kiosk apparatus 100 since the mass of weights 136, 408 will reduce the likelihood that the kiosk apparatus 100 will tip over or be pushed over.

Side support rails 148(a) and 148(b), generally 148 may be used to facilitate motion of the second carriage assembly 134 and weights 138, 408. The support rails 148 may have a recessed portion and a raised portion to prevent the second carriage assembly 134 and weights 136, 408 from contacting an interior surface of the frame 102.

It is also an embodiment of the disclosure that the support rails 148 may have generally circular cross section being formed as substantially round rods. The second carriage assembly 134 may have holes the receive the rods 148 on either side of the second carriage assembly 134. Thus, the second carriage assembly 134 may slide along the rods 148. This embodiment causes the second carriage assembly 134 to move parallel to the rods 148 since the second carriage assembly 132 is in an interference fit with the rods 148.

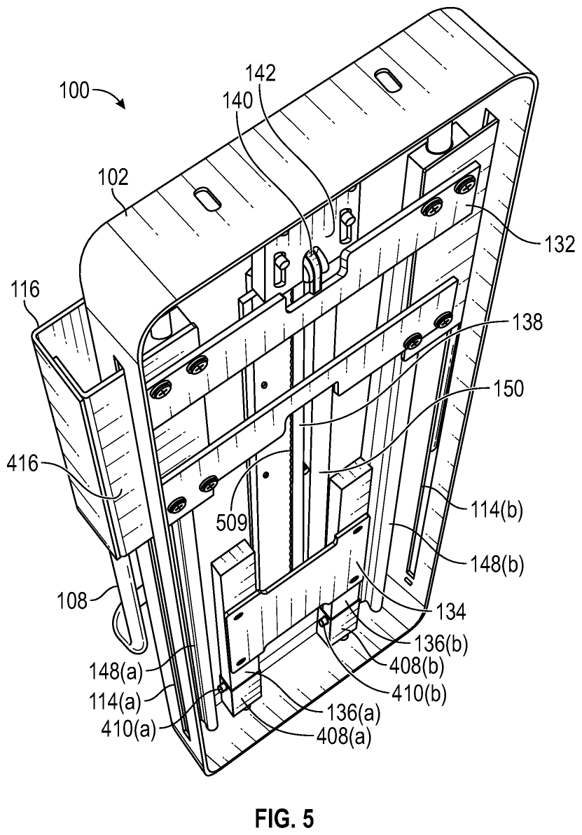

FIG. 5 shows another side/rear view of a kiosk 100 according to yet other embodiments described herein. The kiosk apparatus 100 includes frame portion 102, a first carriage assembly 132 attached to an interface member 116. Also shown is a second carriage assembly 134 attached to one or more weights 136. A linkage 138 is shown connecting the first carriage 132 to the second carriage 134 in a movable relationship such that as one of the first carriage 132 or the second carriage 134 moves in a first substantially vertical path, the other of the first carriage 132 or the second carriage 134 moves in a second substantially vertical path, the first substantially vertical path being different than a second substantially vertical path. Pulley 140 provides guidance for the linkage 138.

FIG. 5 shows middle support rail 150. This rail, while used to provide a track, or path of travel for the second carriage assembly 134, with weights 136 and supplemental weights 410, may also support the weights 136 and 408.

It is therefore an embodiment of the disclosure that the center support 150 may include counter weights used to provide a balance to the first carriage assembly 132.

The other elements shown in FIG. 5 have been previously described herein.

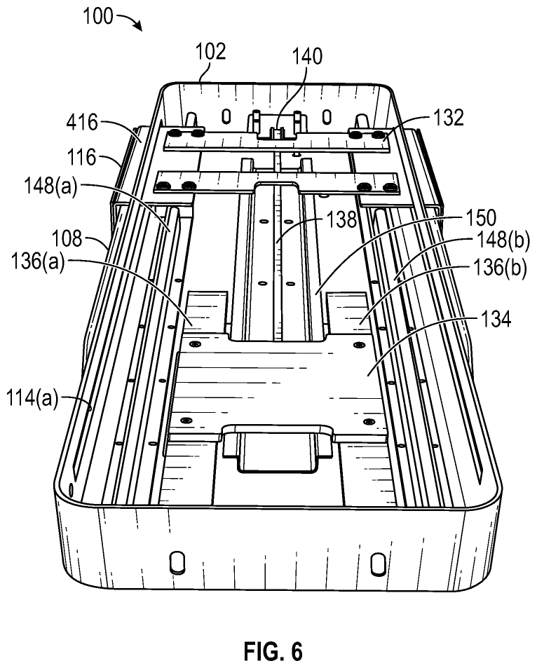

FIG. 6 shows yet another side/rear view of a kiosk 100 according to embodiments described herein.

FIG. 6 shows that the apparatus 100 may also be disposed in a horizontal orientation. The horizontal orientation is similar to the vertical orientation except that the carriage assemblies 132 and 134 move in a horizontal direction, rather than a vertical direction.

The elements shown in FIG. 6 have been previously described herein.

FIG. 7 shows an embodiment 700 that includes a stand-alone frame 102 and an extendable arm member with portions 702 and 704 mounted to interface member 116 via mounting portion 118. The extendable arm, with portions 702 and 704 may include further attachments that may be mounted to mounting surface 703. These further attachments, which may be mounted to mounting surface 703, may include a light, tablet, smartphone, GUI (graphical user interface), biometric sensor, or any suitable object. These objects have been described in relation to objects or devices 104 herein. Top portion 707 and bottom portion 709 of frame 102 are also shown.

As shown herein, it is an embodiment of the disclosure that the kiosk may include a plurality of devices attached to interface member 116. The devices, or object, 104 mounted on interface member 116 may be biometric sensor, which may be a finger print scanner, iris scanner, blood-sample scanner, breathalyzer, or any suitable sensor that can receive biometric data.

It is an embodiment that the kiosk apparatus as described herein may be place in any suitable venue, such as hallways, open areas, conference rooms, airport to purchase airplane tickets, movie theater to purchase tickets, and/or concession vouchers, convention center, ballroom (swipe card and it dispenses drink tickets—parties, festivals, weddings). Since the kiosk apparatus is portable the entire kiosk could be placed in virtually any location.

The kiosk, as described herein may also include a battery, or other power supply, to facilitate additional functionality at the kiosk. This power source could be either AC or DC or a combination of both AC and DC.

While this disclosure is susceptible of embodiment in many different forms, there is shown in the drawings and will herein be described in detail specific embodiments, with the understanding that the present disclosure is to be considered as an example of the principles described and not intended to limit the disclosure to the specific embodiments shown and described. In the description below, like reference numerals are used to describe the same, similar or corresponding parts in the several views of the drawings.

In this document, relational terms such as first and second, top and bottom, and the like may be used solely to distinguish one entity or action from another entity or action without necessarily requiring or implying any actual such relationship or order between such entities or actions. The terms “comprise”, “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Reference throughout this document to “one embodiment”, “certain embodiments”, “an embodiment” or similar terms mean that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

For simplicity and clarity of illustration, reference numerals may be repeated among the figures to indicate corresponding or analogous elements. Numerous details are set forth to provide an understanding of the embodiments described herein. The embodiments may be practiced without these details. In other instances, well-known methods, procedures, and components have not been described in detail to avoid obscuring the embodiments described. The description is not to be considered as limited to the scope of the embodiments described herein.

Unless stated otherwise, terms such as “first” and “second” are used to arbitrarily distinguish between the elements such terms describe. Thus, these terms are not necessarily intended to indicate temporal or other prioritization of such elements.

The various representative embodiments, which have been described in detail herein, have been presented by way of example and not by way of limitation. It will be understood by those skilled in the art that various changes may be made in the form and details of the described embodiments resulting in equivalent embodiments that remain within the scope of the appended claims.

It can be seen that the system and methodologies presented herein provide an advancement in the state of the art.

The various representative embodiments, which have been described in detail herein, have been presented by way of example and not by way of limitation. It will be understood by those skilled in the art that various changes may be made in the form and details of the described embodiments resulting in equivalent embodiments that remain within the scope of the appended claims.

1. An apparatus comprising:
a frame portion;
a first carriage assembly attached to an interface member;
a second carriage assembly attached to one or more weights;
a linkage connecting the first carriage assembly to the second carriage assembly in a movable relationship such that as one of the first carriage assembly or the second carriage assembly moves in a first substantially vertical path within the frame portion, the other of the first carriage assembly or the second carriage assembly moves in a second substantially vertical path, the first substantially vertical path being different than the second substantially vertical path; and
a pulley that provides guidance for the linkage.

2. The apparatus of claim 1, the interface member includes a mounting plate.

3. The apparatus of claim 1, where the first carriage assembly and the interface member have a first mass and the second carriage assembly has a second mass.

4. The apparatus of claim 1, where
a mass of the first carriage assembly is based, at least in part, on one or more objects affixed to the interface member, and
a mass of the second carriage assembly is based, at least in part, on the one or more weights,
the mass of the first carriage assembly being substantially equal to the mass of the second carriage assembly.

5. The apparatus of claim 1, where a first portion of the linkage is attached to a portion of the first carriage assembly and a second portion of the linkage is attached to the second carriage assembly.

6. An apparatus, comprising:
a frame;
a first carriage attached to an interface member;
a second carriage attached to one or more weights;
a linkage connecting the first carriage to the second carriage in a movable relationship such that as one of the first carriage or the second carriage moves in a first substantially vertical path within the frame, the other of the first carriage or the second carriage moves in a second substantially vertical path, the first substantially vertical path being different than a second substantially vertical path;
a pulley that provides guidance for the linkage;
a device affixed to the interface member; and
an actuator affixed to the device that upon actuation causes vertical motion of the device and the actuator controls a position of the device at a desired location on the frame.

7. The apparatus of claim 6, where the actuator is positioned a maximum of 48 inches from a floor surface.

8. The apparatus of claim 6, where the actuator is a handle, a cord, a knob, and a manual actuator.

9. The apparatus of claim 6, where the actuator is substantially U-shaped.

10. The apparatus of claim 1, where the interface member is within four inches of the frame portion.

11. The apparatus of claim 1, where the interface member is adapted to support an object.

12. The apparatus of claim 11, where the object is selected from the group consisting of: a camera, a smartphone, artwork, a tablet, a graphical user interface, and a biometric sensing device.

13. The apparatus of claim 1, where vertical movement of the first carriage assembly maintains a substantially vertical orientation of the interface member.

14. The apparatus of claim 1, further comprising a mounting surface that supports the frame portion.

15. The apparatus of claim 1, where the frame portion is free-standing.

16. The apparatus of claim 1, where the interface member is adapted to support a screen with a biometric sensor.

17. The apparatus of claim 16, where the biometric sensor includes an iris scanner, a finger print scanner, a blood-sample scanner, or a breathalyzer.

18. The apparatus of claim 1, further comprising a mechanical arm that is mounted on the interface member.

19. The apparatus of claim 18, where the mechanical arm is configured to articulate.

20. The apparatus of claim 1, where the one or more weights are selected based on a mass of the interface member and a mass of an object mounted to the interface member.

21. The apparatus of claim 1, where the interface member is located within four inches of the frame portion.

22. The apparatus of claim 1, where the linkage is one or more of a cord, a flexible material with properties that support motion of the first carriage assembly relative to the second carriage assembly, or a belt.

23. The apparatus of claim 1, where the interface member maintains a desired position relative to the frame portion.

24. The apparatus of claim 1, further comprising a second pulley, located at a position different than said pulley, that provides guidance for the linkage.

25. (canceled)
